(19) United States
(12) Patent Application Publication
(10) Pub. No.: US 2010/0216030 A1
(43) Pub. Date: Aug. 26, 2010

(54) POSITIVE ELECTRODE FOR ALL-SOLID SECONDARY BATTERY AND ALL-SOLID SECONDARY BATTERY EMPLOYING SAME

(75) Inventor: Hideaki MAEDA, Osaka (JP)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/708,863

(22) Filed: Feb. 19, 2010

(30) Foreign Application Priority Data
Feb. 20, 2009 (JP) 2009-037729
Jun. 8, 2009 (KR) 10-2009-0050524

(51) Int. Cl. H01M 10/0562; H01M 4/40

(52) U.S. Cl. 429/319; 429/231.95; 429/322

(57) ABSTRACT

A positive electrode for an all-solid secondary battery having excellent rate capabilities and cycle performance and an all-solid secondary battery employing the same. The positive electrode includes a positive electrode active material surface-treated such that at least a part of the surface of the positive electrode active material that is capable of occluding and releasing lithium (Li) is coated with an oxide including at least one of the Group 13 elements.

### CROSS-REFERENCE TO RELATED APPLICATIONS

This application claims the benefit of Japanese Patent Application No. 2009-037729, filed Feb. 20, 2009 in the Japanese Patent Office, and Korean Patent Application No. 10-2009-0050524, filed Jun. 8, 2009 in the Korean Intellectual Property Office, the disclosures of which are incorporated herein by reference.

### BACKGROUND

1. Field

One or more embodiments of the present invention relate to a positive electrode for an all-solid secondary battery having excellent rate capabilities and cycle performance as well as an all-solid secondary battery employing the same.

2. Description of the Related Art

Lithium ion secondary batteries have been widely used in portable information terminals, portable electronic devices, small power storage devices for domestic use, motorcycles using a motor as a power source, electric automobiles, hybrid electric vehicles, etc., due to high electro-chemical capacity, high work potentials, and excellent charge/discharge cycle performance. Accordingly, lithium ion secondary batteries should have excellent safety and high performance. However, since a lithium ion secondary battery using a non-aqueous electrolyte solution, in which a lithium salt is dissolved in an organic solvent, as an electrolyte, easily ignites at about 150° C., the safety of the lithium ion secondary battery is of great concern. Thus, diverse research is being conducted into an all-solid secondary battery using a solid electrolyte formed of a nonflammable inorganic material to improve safety.

Among a sulfide, an oxide, or the like that are used for a solid electrolyte of an all-solid secondary battery, a sulfide solid electrolyte may be used in terms of lithium ion conductivity. However, a sulfide solid electrolyte may react with a positive electrode active material or negative electrode active material at the interface therebetween to generate a resistive component. The generation of the resistive component increases when compounds having different anions are in contact with each other.

Attempts have been made to improve lithium ion conductivity at the interface by contacting different compounds, such as LiI—Al₂O₃, with each other to form a space charge layer. However, the interfacial resistance of the sulfide solid electrolyte may further increase because of the variation of lithium ion concentration and/or the reaction with the positive electrode active material. Japanese Patent Publication No. 2008-103280 discloses a method of coating Li₄Ti₅O₁₂ on a metal oxide of lithium, Li_{Y}XO_{Z}, where X is Co, Mn, or Ni, and Y and Z are respectively integers of 1 to 10. However, the resistive component needs to be further reduced, and the power output of the battery needs to be increased.

In order to increase the power output of secondary batteries using a solid electrolyte, a thin-film solid electrolyte (Japanese Patent Publication No. 2000-340257), a positive electrode active material having an anion that is the same as that of a solid electrolyte (Japanese Patent Publication No. 2007-324079), and a coating of an active material with stable SiO₂ have been used. However, the secondary battery using the thin-film solid electrolyte has low capacity, and the power output and cycle performance of the secondary battery using the positive electrode active material having the same anion as that of the solid electrolyte are not sufficiently improved. In addition, characteristics of the secondary battery are not sufficiently improved by treatment with an oxide such as SiO₂.

### SUMMARY

One or more embodiments of the present invention include a positive electrode for an all-solid secondary battery having excellent rate capabilities and cycle performance and an all-solid secondary battery employing the same.

One or more embodiments of the present invention provide a positive electrode for an all-solid secondary battery including a positive electrode active material surface-treated such that at least a part of the surface of the positive electrode active material that is capable of occluding and releasing lithium is coated with an oxide including at least one of the Group 13 elements.

One or more embodiments of the present invention provide an all-solid secondary battery including: a positive electrode for an all-solid secondary battery incorporating a positive electrode active material surface-treated such that at least a part of the surface of the positive electrode active material that is capable of occluding and releasing lithium is coated with an oxide including at least one of the Group 13 elements; a negative electrode incorporating a negative electrode active material that is capable of being alloyed with lithium or of occluding and releasing lithium; and a solid electrolyte layer incorporating an inorganic solid electrolyte having sulfur and lithium.

The oxide may include an oxide having an X—O bond and an oxide having an Li—X—O bond, where X is a Group 13 element, that is boron (B), aluminum (Al), gallium (Ga), indium (In), or thallium (Tl). In particular, the Group 13 element may include boron (B), aluminum (Al), and/or gallium (Ga).

At least some of the oxides have 4-coordination geometry in which X has a coordination number of 4. The oxides may also include an oxide having 4-coordination geometry and an oxide having 6-coordination geometry in which X has a coordination number of 6.

The inorganic solid electrolyte may include Li₂S; or at least one of the complex compounds Li₂S—P₂S₅, Li₂S—SiS₂, Li₂S—GeS₂, Li₂S—B₂S₃, and Li₂S—Al₂S₃.

As described above, the positive electrode for an all-solid secondary battery includes a positive electrode active material surface-treated such that at least a part of the surface of the positive electrode active material that is capable of occluding and releasing lithium is coated with an oxide including at least one of the Group 13 elements.

The oxide may include an X—O bond (X—O oxide), where X is a Group 13 element, that is boron (B), aluminum (Al), gallium (Ga), indium (In), or thallium (Tl). Since the surface of the positive electrode active material is coated with the X—O oxide, direct contact between the positive electrode active material and the solid electrolyte may be suppressed in the surface-treated positive electrode active material. Thus, the reaction between the positive electrode active material and the solid electrolyte is suppressed at the interface therebetween to prevent the generation of a resistive component.

The oxide may be a lithium oxide having an Li—X—O bond (Li—X—O lithium oxide combination). The Li—X—O lithium oxide combination may function as a channel of lithium ions, and thus lithium ions may be easily diffused using the Li—X—O lithium oxide combination, thereby improving ionic conductivity.

The Group 13 element may be boron (B), aluminum (Al), or gallium (Ga). The X—O oxide or Li—X—O lithium oxide combination including the Group 13 element is easily synthesized. Insulating properties between the positive electrode active material and the solid electrolyte and diffusion properties of lithium ions increase.

At least some of the Group 13 elements (X) of the X—O oxide and the Li—X—O lithium oxide may have a 4-coordination number. Since ions are efficiently diffused in the oxides having the 4-coordination geometry, ion conductivity may be improved by coating the oxides on the surface of the positive electrode active material.

An all-solid secondary battery includes the positive electrode. That is, the all-solid secondary battery includes: a positive electrode for an all-solid secondary battery where the positive electrode incorporates a positive electrode active material surface-treated such that at least a part of the surface of the positive electrode active material that is capable of occluding and releasing lithium is coated with an oxide including at least one of the Group 13 elements; a negative electrode where the negative electrode incorporates a negative electrode active material that is capable of being alloyed with lithium or of occluding and releasing lithium; and a solid electrolyte layer where the solid electrolyte layer incorporates an inorganic solid electrolyte having sulfur and lithium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 shows 4- and 6-coordination geometries of oxides of a Group 13 element; and

FIG. 2 shows graphs of solid-state ²⁷Al—NMR spectra of lithium aluminum oxide.

### DETAILED DESCRIPTION

Reference will now be made in detail to the present embodiments of the present invention, examples of which are illustrated in the accompanying drawings. The embodiments are described below in order to explain the present invention by referring to the figures.

An all-solid secondary battery according to an embodiment of the present invention includes a positive electrode, a negative electrode, and a solid electrolyte layer interposed between the positive electrode and the negative electrode.

Any material that may reversibly occlude and release lithium (Li) ions may be used as a positive electrode active material, without limitation. Examples of the positive electrode active material are lithium cobalt oxides, lithium nickel oxides, lithium cobalt nickel oxides, lithium nickel cobalt aluminum oxides, lithium nickel cobalt manganese oxides, lithium manganese oxides, lithium ferric phosphates, nickel sulfides, copper sulfides, sulfur, iron oxides, vanadium oxides, or the like. These positive electrode active materials may be used alone or in combination.

The positive electrode active material contained in the positive element may be surface-treated such that at least a part of the surface of the positive active material is coated with an oxide of the Group 13 elements. The Group 13 elements are chemically stable because it is difficult for them to be oxidized or reduced. If the surface of the positive electrode active material is coated with an oxide of the Group 13 element, contact between the positive electrode active material and the solid electrolyte may be suppressed, so that reaction between the positive electrode active material and the solid electrolyte is suppressed at the interface therebetween to prevent the generation of a resistive component.

In addition, at least a part of the surface of the positive electrode active material may be coated with an X—O oxide or an Li—X—O Li oxide, or the entire surface of the positive electrode active material may be coated with the X—O oxide or Li—X—O Li oxide, where X is a Group 13 element.

The Group 13 elements may be boron (B), aluminum (Al), gallium (Ga), indium (In), and thallium (Tl), and one or more Group 13 elements may be contained in the oxide. In particular, the oxide may include B, Al, or Ga. The oxides of the Group 13 elements are easily synthesized, and a secondary battery with excellent properties may be obtained by coating the oxides of the Group 13 elements on the positive electrode active material.

The oxide may be an X—O oxide consisting of a Group 13 element X and oxygen, or an Li—X—O oxide consisting of a Group 13 element X, oxygen, and lithium. The surface of the positive electrode active material may be coated with the X—O oxide or the Li—X—O oxide, or both the X—O oxide and the Li—X—O oxide. The X—O oxide has an excellent reaction-suppressing capability between the positive electrode active material and the solid electrolyte at the interface therebetween, and the Li—X—O oxide forms a channel through which lithium ions pass and therefore have excellent lithium ion diffusion properties. Thus, if the X—O oxide is used with the Li—X—O oxide, both suppression of reaction between the positive electrode active material and the solid electrolyte at the interface therebetween and good diffusion of lithium ions may be achieved. Thus, a high power all-solid secondary battery with excellent safety may be prepared.

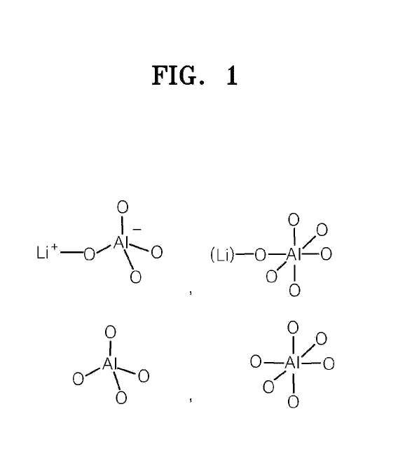

The oxides of the Group 13 elements mainly have 4- and 6-coordination geometries. FIG. 1 shows 4- and 6-coordination geometries of oxides of Group 13 elements. That is, FIG. 1 schematically illustrates that Group 13 elements Xs of the X—O oxide and the Li—X—O oxide have 4- and 6-coordination geometries.

As described above, at least some of the oxides coated on the surface of the positive electrode active material may have 4-coordination geometry. Since the oxide having 4-coordination geometry has excellent Li ion diffusion properties, ion conductivity may be improved by coating the positive electrode active material with the oxide having 4-coordination geometry in order to increase power output. The surface of the positive electrode active material may be coated only with oxides having 4-coordination geometry, or with both oxides having 4-coordination geometry and oxides having 6-coordination geometry. Even though the oxide having 6-coordination geometry does not have sufficient Li ion diffusion properties, reaction between the chemically stable positive electrode active material and the solid electrolyte at the interface therebetween is efficiently suppressed by the oxide having 6-coordination geometry. Thus, if the oxide having 4-coordination geometry and the oxide having 6-coordination geometry are used together, both suppression of reaction between the positive electrode active material and the solid electrolyte at the interface therebetween and good diffusion of Li ions may be achieved. Thus, a high power all-solid secondary battery with excellent safety may be prepared.

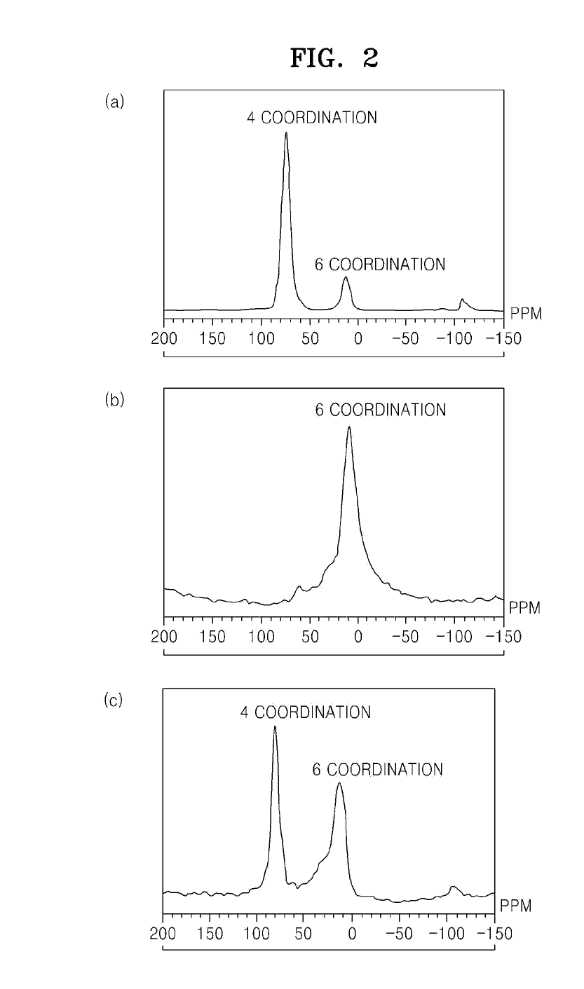

FIG. 2 shows graphs of solid-state ²⁷Al—NMR spectra of lithium aluminum oxide having an Li—Al—O bond, obtained as described in Example 1 using a nuclear magnetic resonance (NMR) spectrometer (Varian NMR System 400 WB) at an observance frequency of 104.35 MHz with a probe diameter of 2.5 mm φ (diameter). As shown in FIG. 2(a), too high a concentration of 4-coordination geometries may lead to insufficient diffusion of lithium ions. As shown in FIG. 2(b), too high a concentration of 6-coordination geometries may lead to insufficient suppression of the reaction between the positive electrode active material and the solid electrolyte at the interface therebetween. On the other hand, if the ratio of the oxides having 4-coordination geometries to the oxides having 6-coordination geometries is about 1:1, as shown in FIG. 2(c), the suppression of the reaction between the positive electrode active material and the solid electrolyte at the interface between and the Li ion diffusion may be well-balanced.

The surface of the positive electrode active material may be coated with the oxides by methods such as immersing positive electrode active material particles in a precursor solution of the oxides and heat-treating the resultant, and spraying a precursor solution of the oxides on the positive electrode active material particles and heat-treating the resultant. The precursor of the oxides may be an alkoxide of the Group 13 elements, and the alkoxide of the Group 13 elements may be dissolved in an organic solvent to prepare the precursor solution.

Photographs of the cross-sections of a positive electrode active material before and after coating with aluminum isopropoxide as a precursor of an oxide and heat-treating the resultant were obtained by wavelength dispersive X-ray (WDX) analysis using a scanning electron microscope (SEM). Inspection of the photograph taken after the surface-treatment shows that the surface of the positive electrode active material that is surface-treated emits fluorescence, confirming that the surface after the surface-treatment is coated with aluminum oxide.

Any material that is capable of being alloyed with Li or of reversibly occluding and releasing lithium may be used as a negative electrode active material. For example, a metal such as lithium, indium, tin, aluminum, and silicon, or any alloy of the metal; an oxide of a transition metal such as Li_{4/3}Ti_{5/3}O₄ and SnO; a carbonaceous material such as artificial graphite, graphite carbon fiber, resin-calcined carbon, pyrolyzed vapor-grown carbon, coke, mesocarbon microbeads (MCMB), furfuryl alcohol resin, calcined carbon, polyacenes, pitch-based carbon fiber, vapor-grown carbon fiber, natural graphite, and non-graphitizable carbon may be used as the negative electrode active material. These negative electrode active materials may be used alone or in a combination.

Additives such as an electrically conductive agent, an adhesive agent, an electrolyte, a filler, a dispersing agent, or an ion conducting agent may be added to powder of the active material used to prepare the positive electrode and the negative electrode. The electrically conductive agent may be graphite, carbon black, acetylene black, Ketjen black, carbon fiber, metal powder, or the like. The adhesive agent may be polytetrafluoroethylene, polyfluorovinylidene, polyethylene, or the like. The electrolyte may be a sulfide solid electrolyte described below.

The positive electrode or negative electrode may be prepared by adding the active material and a mixture of various additives to a solvent such as water or an organic solvent to prepare a slurry or paste, coating the slurry or paste on a current collector using, for example, a “doctor blade”, drying the coated slurry or paste, and pressing the coated slurry or paste using a rolling roller. The current collector may be a plate, sheet, or film formed of indium, copper, magnesium, stainless steel, titanium, iron, cobalt, nickel, zinc, aluminum, germanium, lithium or any alloy thereof.

The positive electrode or negative electrode may be prepared in a pellet form without using the current collector. When a metal or an alloy thereof is used as the negative electrode active material, the metal or alloy sheet may be used as the negative electrode without using the current collector.

The solid electrolyte layer includes a sulfide solid electrolyte. The sulfide solid electrolyte may be any inorganic solid electrolyte including sulfur and Li. For example, the sulfide solid electrolyte may be Li₂S, or a complex compound such as Li₂S—P₂S₅, Li₂S—SiS₂, Li₂S—GeS₂, Li₂S—B₂S₃, and Li₂S—Al₂S₃. The solid electrolyte layer may be prepared in a pellet form by pressing the sulfide solid electrolyte.

The all-solid secondary battery according to an embodiment of the present invention may be prepared by stacking the positive electrode, the solid electrolyte layer, and the negative electrode, and pressing the resultant.

Hereinafter, one or more embodiments of the present invention will be described in detail with reference to the following examples. However, these examples are not intended to limit the purpose and scope of the one or more embodiments of the present invention.

### Example 1

An In film having a thickness of 0.05 mm, which was used as a negative electrode, was punched to have a diameter of 13 mm and set in a cell. 80 g of Li₂S—P₂S₅ (80-20 mol %) (SE), which is a solid electrolyte, was treated by mechanical milling (MM) and stacked thereon, and the surface of the solid electrolyte was trimmed. In addition, lithium cobalt oxide (LiCoO₂) particles, as a positive electrode active material, were dispersed in ethanol. Aluminum isopropoxide was dissolved therein such that the amount of Al was 0.05 wt %, and the mixture was heat-treated to prepare a positive electrode active material coated with lithium aluminum oxide having an Li—Al—O bond. Then, the surface-treated positive electrode active material, the SE, and vapor-grown carbon fiber (VGCF) as an electrically conductive agent were mixed in a ratio of 60:35:5 wt %, and the mixture, as a composition for the positive electrode, was stacked on the SE. The resultant was pressed at a pressure of 3 ton/cm² to prepare a pellet of a test cell.

The test cell was charged with a constant current of 0.02 C at 25° C. until reaching an upper limit voltage of 4 V to measure an initial capacity. Then, the test cell was discharged with a current of 0.1 C until reaching a final discharge voltage of 1 V. The charging and discharging were repeated. After 50 cycles of the charging and discharging, a capacity retention rate with respect to the initial capacity was measured to evaluate cycle performance of the test cell.

In addition, in the first stage, the test cell was charged with a constant current of 0.02 C until reaching an upper limit voltage of 4 V and discharged with a current of 0.02 C. In the second stage, the test cell was charged in the same manner as in the first stage and discharged with a constant current of 0.1 C. Then, the rate of the capacity of the second stage/the capacity of the first stage (%) was measured to evaluate rate characteristics of the test cell.

### Example 2

A test cell was prepared in the same manner as in Example 1, except that the positive electrode active material was surface-treated such that the amount of Al added was 0.1 wt %. Then, characteristics of the test cell were evaluated.

### Example 3

A test cell was prepared in the same manner as in Example 1, except that the positive electrode active material was surface-treated such that the amount of Al added was 0.2 wt %. Then, characteristics of the test cell were evaluated.

### Example 4

A test cell was prepared in the same manner as in Example 1, except that the positive electrode active material was surface-treated such that the amount of Al added was 0.5 wt %. Then, characteristics of the test cell were evaluated.

### Example 5

A test cell was prepared in the same manner as in Example 1, except that boron isopropoxide was used instead of aluminum isopropoxide, and the positive electrode active material was surface-treated such that the amount of B added was 0.1 wt %. Then, characteristics of the test cell were evaluated.

### Example 6

A test cell was prepared in the same manner as in Example 1, except that gallium isopropoxide was used instead of Al isopropoxide, and the positive electrode active material was surface-treated such that the amount of Ga added was 0.1 wt %. Then, characteristics of the test cell were evaluated.

### Comparative Example 1

A test cell was prepared in the same manner as in Example 1, except that the positive electrode active material was not surface-treated. Then, characteristics of the test cell were evaluated.

### Comparative Example 2

A test cell was prepared in the same manner as in Example 1, except that the positive electrode active material was not surface-treated, and aluminum oxide was added during the preparation of the positive electrode such that the amount of Al added was 0.05 wt %. Then, characteristics of the test cell were evaluated.

### Comparative Example 3

A test cell was prepared in the same manner as in Example 1, except that the positive electrode active material was not surface-treated, and aluminum oxide was added during the preparation of the positive electrode such that the amount of Al added was 0.5 wt %. Then, characteristics of the test cell were evaluated.

### Comparative Example 4

A test cell was prepared in the same manner as in Example 1, except that the positive electrode active material was not surface-treated, and boron oxide was added during the preparation of the positive electrode such that the amount of B added was 0.5 wt %. Then, characteristics of the test cell were evaluated.

### Comparative Example 5

A test cell was prepared in the same manner as in Example 1, except that the positive electrode active material was not surface-treated, and gallium oxide was added during the preparation of the positive electrode such that the amount of Ga added was 0.5 wt %. Then, characteristics of the test cell were evaluated.

The results obtained in Examples 1 to 6 and Comparative Examples 1 to 5 are shown in Table 1 below.

TABLE 1

| | | Ele- | Amount of the | Rate | Cycle |
|---|---|---|---|---|---|
| | | ment | element | characteristics | characteristics |
| | | added | added (wt %) | (%) | (%) |
| Examples | 1 | Al | 0.05 | 86 | 76 |
| | 2 | Al | 0.10 | 87 | 88 |
| | 3 | Al | 0.20 | 82 | 80 |
| | 4 | Al | 0.50 | 80 | 72 |
| | 5 | B | 0.10 | 83 | 84 |
| | 6 | Ga | 0.10 | 82 | 83 |
| Compar- | 1 | — | — | 37 | 28 |
| ative | 2 | Al | 0.05 | 40 | 52 |
| Examples | 3 | Al | 0.50 | 62 | 45 |
| | 4 | B | 0.50 | 58 | 38 |
| | 5 | Ga | 0.50 | 54 | 41 |

Referring to Table 1, if the surface of the positive electrode active material is coated with an oxide of a Group 13 element, the test cell has high capacity and excellent rate capabilities and cycle performance. On the other hand, if the oxide of Group 13 element is simply mixed with the composition for the positive electrode, the surface of the positive electrode active material is not coated with the oxide of the Group 13 element, and thus the test cell has low capacity and poor rate capabilities and cycle performance. As described above, a high power all-solid secondary battery with excellent safety may be prepared.

Generally, an all-solid secondary battery using a sulfide solid electrolyte has a high interfacial resistance between a positive electrode active material and a solid electrolyte. However, in an all-solid secondary battery according to one or more of the above embodiments of the present invention, the surface of the positive electrode active material is coated with an Li—X—O compound, wherein X is Group 13 elements, which are B, Al, Ga, In, and Tl, and the coating layer may suppress direct contact between the solid electrolyte and the positive electrode active material, and thus generation of resistive component at the interface may be suppressed. In addition, since the surface of the positive electrode active material is coated with the Li—X—O compound, the decrease of the concentration of Li ions may be suppressed at the interface between the positive electrode active material and the solid electrolyte. In addition, since a channel through which the Li ions pass is formed, the interfacial resistance between the positive electrode active material and the solid electrolyte may also be reduced. Thus, an all-solid secondary battery having excellent rate capabilities and cycle performance may be obtained.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A positive electrode for an all-solid secondary battery comprising a positive electrode active material surface-treated such that at least a part of the surface of the positive electrode active material that is capable of occluding and releasing lithium (Li) is coated with an oxide comprising at least one of the Group 13 elements.

2. The positive electrode for an all-solid secondary battery of claim 1, wherein the oxide comprises at least one selected from the group consisting of an oxide having an X—O bond and an oxide having an Li—X—O bond and X is a Group 13 element, which is boron (B), aluminum (Al), gallium (Ga), indium (In), or thallium (Tl).

3. The positive electrode for an all-solid secondary battery of claim 2, wherein the Group 13 element is at least one element selected from the group consisting of B, Al, and Ga.

4. The positive electrode for an all-solid secondary battery of claim 2, wherein some of the oxides have 4-coordination geometry in which X has a coordination number of 4.

5. The positive electrode for an all-solid secondary battery of claim 3, wherein the oxides comprise an oxide having 4-coordination geometry and an oxide having 6-coordination geometry, in which X is a coordination number of 6.

6. An all-solid secondary battery comprising:
a positive electrode comprising a positive electrode active material surface-treated such that at least a part of the surface of the positive electrode active material that is capable of occluding and releasing lithium (Li) is coated with an oxide comprising at least one of the Group 13 elements;
a negative electrode comprising a negative electrode active material capable of being alloyed with lithium or of occluding and releasing lithium; and
a solid electrolyte layer comprising an inorganic solid electrolyte having sulfur and lithium.

7. The all-solid secondary battery of claim 6, wherein the oxide is at least one selected from the group consisting of an oxide having an X—O bond and an oxide having an Li—X—O bond, wherein X is a Group 13 element, which is boron (B), aluminum (Al), gallium (Ga), indium (In), or thallium (Tl).

8. The all-solid secondary battery of claim 7, wherein the Group 13 element is at least one element selected from the group consisting of B, Al, and Ga.

9. The all-solid secondary battery of claim 7, wherein some of the oxides have 4-coordination geometry in which X has a coordination number of 4.

10. The all-solid secondary battery of claim 8, wherein the oxides comprise an oxide having 4-coordination geometry and an oxide having 6-coordination geometry in which X has a coordination number of 6.

11. The all-solid secondary battery of claim 6, wherein the inorganic solid electrolyte is at least one compound selected from the group consisting of Li₂S, Li₂S—P₂S₅, Li₂S—SiS₂, Li₂S—GeS₂, Li₂S—B₂S₃, and Li₂S—Al₂S₃.
